(19) United States
(12) Patent Application Publication
(10) Pub. No.: US 2016/0100682 A1
(43) Pub. Date: Apr. 14, 2016

(54) Brush Drying Support and Method of Using Same

(71) Applicant: Diane Lee, Richmond, VA (US)

(72) Inventor: Diane Lee, Richmond, VA (US)

(21) Appl. No.: 14/511,588

(22) Filed: Oct. 10, 2014

(51) Int. Cl. A46B 17/08; F16M 13/00; F16B 2/00

(52) U.S. Cl. CPC A46B 17/08; F16B 2/005; F16M 13/00

(57) ABSTRACT

The present invention relates to a new brush drying support and method for drying brushes, on the support. The invention comprises a support, comprised of a structure with a generally planar top portion, disposed at an optimal angle for retaining and draining brushes. This top portion is covered with a gripping material that holds brushes placed directly on the support, without requiring further retaining means. The proper method for retaining and draining a wet brush occurs when a brush is placed on an angled top portion of said support, with the brush stem located above the brush head. Further, the brush head overhangs the bottom edge of the top (angled) portion of the support. This novel brush support, and method of drying brushes, provide several advantages over the prior art; namely, improved cleanliness of the brush head, preservation and longevity of the brush head, support of multiple brushes in a small space, and improved user accessibility to brushes. Further, the invention provides compact brush storage without slots, holes or bulky retaining means.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The present invention is in the technical field of HOLDERS/SUPPORTS. More particularly, the present invention is in the technical field of BRUSH HOLDERS. More particularly, the present invention relates to BRUSH DRYING SUPPORTS.

Historically, cosmetic and/or artistic brush holders have been designed to maintain brushes in a vertical position to allow for the brushes to dry over time. As an example, see U.S. Pat. No. 8.720,703, issued May 13, 2014, to Pressler (“the '703 Patent”), and U.S. Pat. No. 7,234,602, issued Jun. 26, 2007, to Roberti (“the '602 Patent”). A problem with supporting brushes in the vertical position is that it is not the optimal angle to preserve the cleanliness, shape and quality of the brush.

Optimally, to allow the water to properly drain off the brush, the brush head should be stored below the brush stem, to insure drainage and non-collection of moisture in the brush head. Though the '602 Patent teaches storing a brush at an angle in one embodiment, the brush head is stored above the brush stem. This arrangement prevents water from optimally draining downward off the bristles of the brush head.

Further, the '602 Patent demonstrates brush supports in which a user must insert a brush into a hole or slot for brush drying. Additional brushes must be secured in the same way, and therefore a large support structure with multiple holes or slots is needed, to secure multiple brushes.

Presently there is a need for a brush support that can secure brushes for drying and for storage, at an optimal angle, such that water does not collect in the brush head. When water collects in the brush head, it can loosen the glue that attaches the bristles to the brush head, and compromise the quality of the brush. Further, bacteria can collect in the brush head. Storing the brush at an optimal angle, therefore, will help preserve the brush's longevity, shape and cleanliness.

There is also a need in the art for a compact brush support that holds a multitude of brushes at once within a small amount of space. A further need within the art is for a simple brush support that retains a brush without the use of a hole or slot. The ideal support configuration would allow a user to easily store and retrieve a brush directly from the support surface.

### SUMMARY OF THE INVENTION

The present invention relates to a new brush drying support and method for drying brushes, on the support. The invention comprises a support, comprised of a structure with a generally planar top portion, disposed at an optimal angle for retaining and draining brushes. This top portion is covered with a gripping material that holds brushes placed directly on the support, without requiring further retaining means. The proper method for retaining and draining a wet brush occurs when a brush is placed on an angled top portion of said support, with the brush stem located above the brush head. Further, the brush head overhangs the bottom edge of the top (angled) portion of the support. This novel brush support, and method of drying brushes, provide several advantages over the prior art; namely, improved cleanliness of the brush head, preservation and longevity of the brush head, support of multiple brushes in a small space, and improved user accessibility to brushes. Further, the invention provides compact brush storage without slots, holes or bulky retaining means.

### BRIEF DESCRIPTION OF THE DRAWINGS

FIG. 1 is a front elevational view of a brush support constructed in accordance with one exemplary embodiment of the present invention;

FIG. 2 is a left side view of the brush support of FIG. 1; the right side of the support of FIG. 1 is a mirror-image of the left side.

FIG. 3 is a front elevational view of the brush support of FIG. 1.

FIG. 3A is a sectional view of the brush support, taken along the line 3-3 of FIG. 3.

FIG. 4 is a back elevational view of the brush support of FIG. 1;

FIG. 5 is a duplicate sectional view of the brush support of FIG. 3A, with annotated angles added.

FIG. 6 is a duplicate sectional view of the brush support of FIG. 3A, depicting a brush properly placed upon said support.

### DETAILED DESCRIPTION OF THE INVENTION

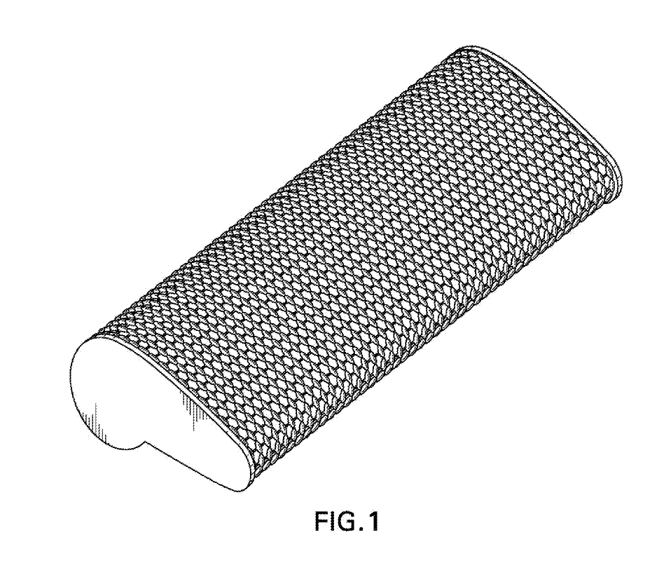

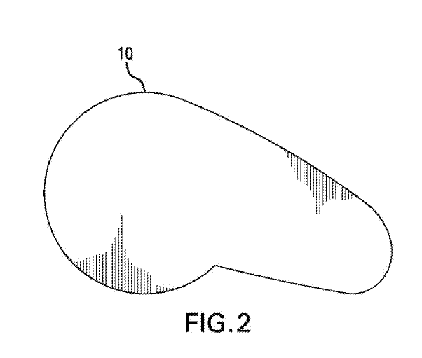

Referring now to the invention in more detail, see FIG. 1 to FIG. 4. These figures show a brush support 1 intended to support cosmetic brushes or similar types of brushes, including but not limited to artist and/or paint brushes, for drying and storage. It is intended that different embodiments of the invention may be used and structural changes may be made without departing from the scope and spirit of the invention. The following detailed description should not be limited to the embodiments shown, but rather, should be read broadly to enable similar embodiments. The scope of the present invention is defined by the claims.

Referring to FIG. 1 to FIG. 4, the brush support 1 is generally comprised of a structure 2, gripping material 3 and end pieces 10. Structure 2 is generally comprised of a generally planar top portion 5, a generally curved back portion 4, a generally planar bottom portion 6 and a generally curved front portion 7. As depicted in FIG. 1 to FIG. 4, generally planar top portion 5 of structure 2 has a top edge 9 and a bottom edge 8. Top edge 9 sits above bottom edge 8. In the preferred embodiment, as depicted in FIG. 1 to FIG. 4, gripping material 3 is applied over the top portion 5, back portion 4, bottom portion 6, and front portion 7 of structure 2. End pieces 10 are attached to the left and right sides of structure 2, respectively.

The construction details of the preferred embodiment of the invention, as shown in FIG. 1 to FIG. 4, include, but are not limited to, the following description.

Structure 2 may be made out of one or more of any series of structural material, including but not limited to: plastic, glass, foam or any other material that do not generally absorb water, and that can be manipulated to make a solid shape, or a solid or hollow mold, of the general shape depicted in FIG. 1.

End pieces 10 may be made of the same material described above for structure 2. Gripping material 3 may include any material that can grip cosmetic brushes, or similar types of brushes, including but not limited to artist and/or paint brushes, without sticking to them. Such gripping material 3 may include, but is not limited to, the material found in non-slip rug pads. The gripping material 3, depicted on the preferred embodiment represented in FIG. 1 to FIG. 4, is a rug pad material, made from a scrim and polyvinyl chloride (“PVC”) combination, made as described below. This method is generally known in the art.

To begin, a “scrim,” made of natural or synthetic fibers, is either knitted or woven into a network having intermittent openings spaced along the surface of the scrim, in a repeating pattern. The scrim is then dipped in liquid PVC and cured in an oven. Upon curing, a chemical reaction occurs and the PVC solidifies to produce a soft, resilient, elastomeric foam or plastisol material, over the scrim. The resulting pad has openings that are smaller than the original openings in the base scrim. The pad openings in the preferred in embodiment (FIGS. 1-4) may be hexagonal as shown, but may also be rectangular, triangular, diamond-shaped, octagonal, or any other combination of shapes. The example of a rug pad product, depicted in FIG. 1 to FIG. 4, is marketed and sold under the product name ULTRA STOP by MSM Industries, under the trade name, GRIP-IT. However, various other non-slip rug pad brands, or other products displaying non-slip properties may be used as the gripping material 3, in other embodiments of the invention.

Non-slip rug pad materials that are well-known in the art include a base PVC material, (made as described above) coated with a non-slip coating material, to improve the non-slip properties of the base PVC material. In addition, anti-microbial coatings may be added to the dried PVC material, to prevent the development of mold or mildew on the pad or items touching the PVC material.

Returning to the construction details of FIG. 1 to FIG. 4, the gripping material 3 is affixed to said structure 2 by water-based glue product. Alternatively, other adhesive methods may be used to connect the gripping material 3 to said structure 2. Said methods may include latex-based, water-based, solvent-based or acrylic-based adhesives, or any other adhesion technique that enables gripping material 3 to stay in place on structure 2, without damaging or compromising the shape and durability of structure 2. Of note is that the gripping material 3 is primarily needed on the generally planar top portion 5 of structure 2, because it the gripping material 3 is designed to grip a brush placed on the top portion 5 of structure 2, to promote optimal brush drying and storage.

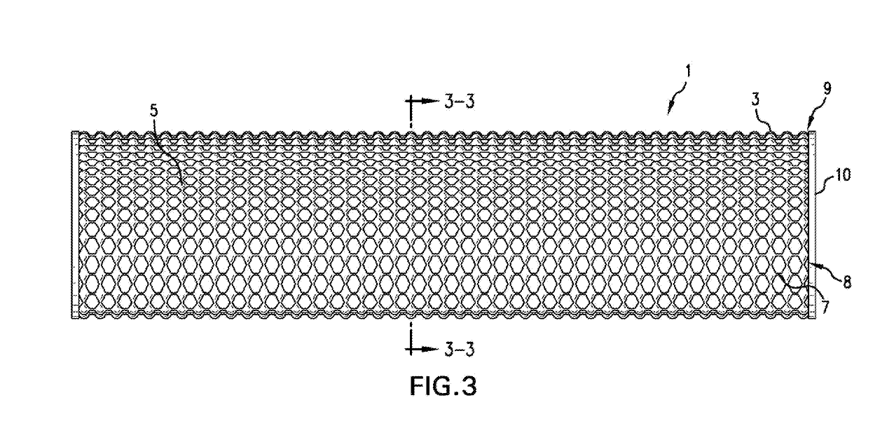

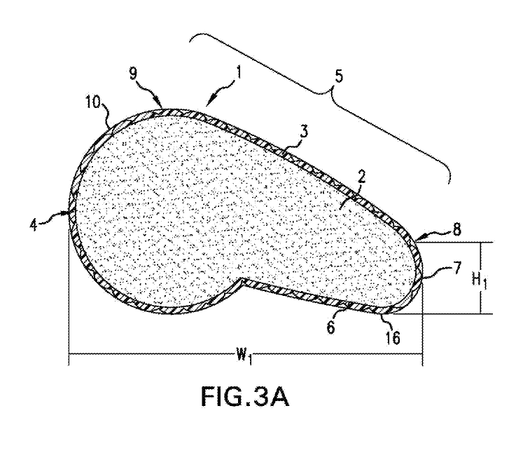

Referring further to the construction details of FIG. 3A, the width W1 of said support may be from six (6) to eighteen (18) inches. However, when a compact support design is desired, W1 of the support should ideally be twelve inches or less. The height H1 from the bottom edge 8 of top portion 5 to the lowest point on bottom portion 6 (see FIG. 3A) is ideally one-half (½) inch to two and one-half (2½) inches.

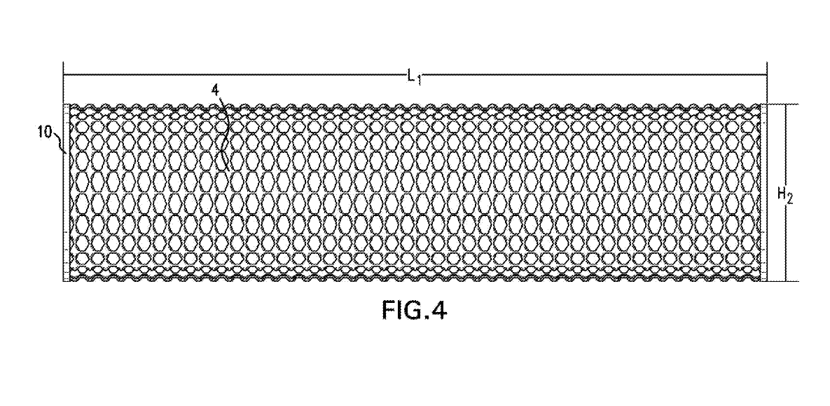

Referring to FIG. 4, the length L1 of said support 1 may be between six (6) and twenty-four (24) inches. However, when a compact support design is desired, the length L1 should ideally be twelve (12) inches or less. The height H2 may be from two and one half (2½) to five (5) inches. These dimensions represent the sizes at which the support can be made to function as intended, to support cosmetic and/or artistic and/or paint brushes. However, it is conceivable that these dimensions could be enlarged if the objective of the invention was simply to dry a multitude of brushes of different or larger sizes, without trying to save on space.

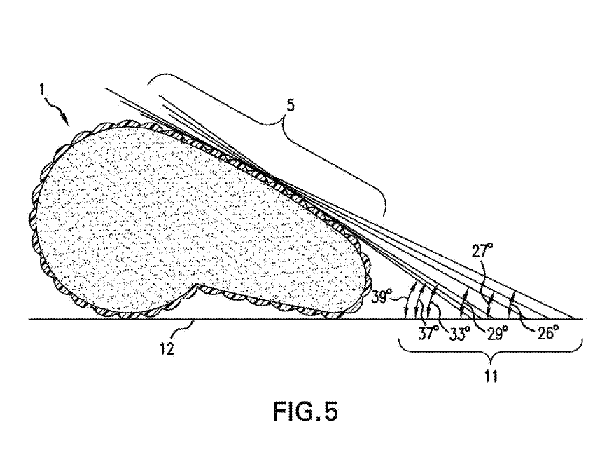

Referring now to the proper angle at which brushes must be placed on the preferred embodiment of support 1 (as depicted in FIG. 1-4), please refer to FIG. 5. FIG. 5 is a duplicate representation of FIG. 3A, but with edge piece 10 removed, and plane 12 added. FIG. 5 demonstrates a series of angles 11 at which the generally planar top portion 5 should be constructed to insure a brush can rest and remain on structure 2, when a brush is properly placed on support 1 to dry. Angle 11 should be between twenty-five (25) and forty (40) degrees, as measured from the plane 12 to a line adjacent to top portion 5 of support 1, as demonstrated in FIG. 5.

Notwithstanding the foregoing description of the preferred embodiment of support 1, variations and alternate embodiments of the invention may exist. Alternate embodiments may encompass other support designs, and may provide added structural benefits, without departing from the scope and spirit of the invention.

In particular, additional contemplated features include, but are not limited to, adding a lip (of the same general length as top portion 5) to the top edge of each end piece 10 (as depicted in FIGS. 1-4). Each lip would be made of the same material as structure 2 (as described earlier in this specification), and would extend upwards from each end piece 10. The lip would ideally extend one-fourth (¼) to two (2) inches from the upper edge of end piece 10, generally along the length of top portion 5, from top edge 9 to bottom edge 8 (as depicted in FIG. 1-FIG. 4). The purpose of the lip would be to provide a retaining wall to prevent a brush, placed on top portion 5, near each edge piece 10, from falling off the support 1.

Further design differences may include making front portion 7 and back portion 4 generally planar in appearance, instead of curved. Further, top portion 5 and bottom portion 6 of structure 2 may be altered in shape, as long as top portion 5 of structure 2 retains brushes at the optimal angles described above (see FIG. 5 description).

Furthermore, in another embodiment of the invention, end pieces 10 would not be separable from structure 2, as described in the preferred embodiment description above, of FIGS. 1-4. Instead, the end pieces would be made of a single set of materials forming structure 2 during the manufacturing process (e.g., as part of a single mold or composition).

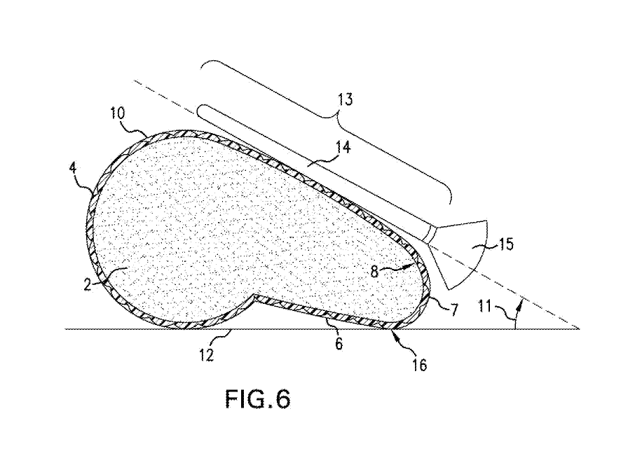

Referring now to a new method of drying brushes, please refer to FIG. 6. FIG. 6 demonstrates a new method for draining and storing brushes, to insure brush head cleanliness, longevity and quality. To achieve these objectives, a user places a brush 13 on support 1 as generally depicted in FIG. 6. The user places brush stem 14 of brush 13 on top portion 5 of structure 2, such that the brush head 15 slightly overhangs bottom edge 8 of top portion 5. Note that gripping material 3 covers top portion 5, and gripping material 3 grips the brush when it is placed on the support 1 as described. By insuring that the brush head 15 slightly overhangs edge 8, a user will insure the brush head 15 drains thoroughly, and that no water collects in the brush head, thereby reducing bacterial contamination. Furthermore, placing the brush at an angle 11, with the brush head located below the brush stem, prevents collection of water in the brush head, and thus prevents the glue in the brush head (that joins the brush bristles to the brush ferrule), from loosening. By storing brush 13 in the manner described above, a user will insure that the brush properly drains and that the shape, quality and longevity of the brush head 15 is preserved.

The advantages of the present brush support invention include the following: an angled gripping surface upon which brushes are gripped and retained by the support surface itself; reduction of bacterial contamination in the brush head; preservation of brush head shape and quality, support of a multitude of brushes in a small amount of space, and easy brush retrieval by a user. Further, no slots or holes are required as a brush retaining means, in the new drying support.

The new method of drying brushes on the new brush support provides the following advantages, similar to those listed above; namely, improved brush head drainage, improved brush head cleanliness, and brush head shape preservation.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiments, methods, and examples, but should include all embodiments and methods within the scope and spirit of the invention.

1. A support for holding and drying brushes, comprising:
a structure comprising:
a generally planar top portion having a generally rectangular shape; and
wherein said generally planar top portion comprises a top edge and a bottom edge; and
wherein said generally planar top portion is positioned at an angle such that when said support is at rest, said top edge of said top portion is situated above said bottom edge of said top portion.

2. The support of claim 1, further comprising:
a gripping material covering said generally planar top portion.

3. The support of claim 2, wherein said generally planar top portion of said structure is constructed to support a brush resting on said top portion at an angle of 25 to 40 degrees from a horizontal plane on which said support rests.

4. The support of claim 2, wherein said gripping material comprises:
a base scrim material coated in a polyvinyl chloride plastisol or foam.

5. The support of claim 4, wherein said gripping material is a non-slip rug pad material.

6. The support of claim 5, wherein said non-slip rug pad material is marketed under the name ULTRA STOP by MSM Industries under the trade name GRIP-IT.

7. The support of claim 2, wherein said structure further comprises:
a front portion, connecting to said generally planar top portion and said generally planar bottom portion; and
a back portion, connecting to said generally planar top portion and said generally planar bottom portion of said structure.

8. The support of claim 7,
wherein said structure further comprises:
a right side and a left side; and
wherein said support further comprises:
a first and second generally planar end piece;
wherein said first end piece is connected to said left side of said structure; and
wherein said second end piece is connected to said right side of said structure.

9. The support of claim 8, wherein said top portion, bottom portion, front portion and back portions of said structure, in combination with said end pieces, are constructed from a single mold.

10. The support of claim 9, wherein said structure further comprises:
A first lip extending from said top edge of said first end piece; and
a second lip extending from said top edge of said second end piece;
wherein said first lip extends above said top edge of said first end piece; and
wherein said second lip extends above said top edge of said second end piece; and
wherein said first lip and said second lip extend generally in length from said top edge to said bottom edge of said generally planar top portion of said structure.

11. The support of claim 8, wherein said first and second end pieces have a general teardrop shape.

12. The support of claim 8, wherein said end pieces have a general rectangular shape.

13. A method of storing and drying brushes, said method comprising:
placing a brush on a brush support, wherein:
said brush comprises a brush stem and brush head; and
wherein said brush support comprises:
a structure comprising:
a generally planar top portion having a generally rectangular shape; and
wherein said generally planar top portion comprises a top edge and a bottom edge; and
wherein said generally planar top portion is positioned such that when said support is at rest, said top edge of said top portion is situated above said bottom edge;
wherein said brush stem rests on said generally planar top portion at an angle generally perpendicular to said bottom edge; and
wherein said brush stem is situated above said brush head on said support; and
wherein said brush head slightly overhangs said bottom edge.

14. The method of claim 13, wherein said generally planar top portion is constructed to support a brush resting on said top portion at an angle of 25 to 40 degrees from a horizontal plane, upon which said brush support rests.

15. The method of claim 13, wherein said structure of said brush support further comprises:
a generally planar bottom portion situated generally away from said generally planar top portion;
a front portion, connecting said generally planar top portion and said generally planar bottom portion; and
a back portion, connecting said generally planar top portion and said generally planar bottom portion.
